(19) United States
(12) Patent Application Publication
(10) Pub. No.: US 2011/0042953 A1
(43) Pub. Date: Feb. 24, 2011

(54) EMBEDDED TURBINE GENERATOR SET

(75) Inventors: Chi-Rong Kuo, Taoyuan County (TW); Chih-Wei Yen, Hsinchu City (TW); Ta-Wei Wang, Taipei County (TW); Yuh-Ren Lee, Hsinchu County (TW); Buo-Hua Hsu, Hsinchu County (TW)

Correspondence Address: WPAT, PC;INTELLECTUAL PROPERTY ATTORNEYS, 7225 BEVERLY ST., ANNANDALE, VA, 22003, US

(73) Assignee: Industrial Technology Research Institute, Hsinchu (TW)

(21) Appl. No.: 12/790,916

(22) Filed: May 31, 2010

(30) Foreign Application Priority Data
Aug. 21, 2009 (TW) 098128148

(51) Int. Cl. F01D 15/10; H02K 7/18

(52) U.S. Cl. 290/52

(57) ABSTRACT

This disclosure relates to a turbine generator set, in which an axial-flow turbine and a generator are embedded inside a flow channel. In an exemplary embodiment of the disclosure, the turbine generator set comprises: a flow channel being provided with a front end as an inlet duct and a back end as an outlet duct; an axial-flow turbine, being single-stage or multi-stage, capable of transforming thermal and pressure energies of a working fluid inside the flow channel into rotational energy; and a generator, comprising a rotor and a stator, being capable of transforming the rotational energy into electricity. A shaft of the turbine and a shaft of the generator can be coupled directly or by way of a gear set. Electricity is transmitted from the flow channel by way of a bunch of cables passing through the flow channel.

### TECHNICAL FIELD

This disclosure generally relates to a turbine generator set and, more particularly, to an embedded turbine generator set, in which an axial-flow turbine and a generator are embedded inside a flow channel so as to prevent working fluid leakage without any shaft seal mechanism.

### TECHNICAL BACKGROUND

The turbine generator is capable of transforming thermal and pressure energies of a working fluid into rotational energy and then transforming the rotational energy into electricity. The stator and the rotor of the turbine receive the working fluid and transform the energy of the working fluid, while the generator receives the rotational energy from the turbine to output electricity.

FIG. 1 is a cross-sectional diagram of a conventional turbine generator. In the turbine generator in FIG. 1, the turbine 8 is disposed in the housing and communicates with the flow channel, while the generator 9 is disposed outside the flow channel. The generator shaft is coupled to the turbine rotor 81 directly or by way of a shaft coupler.

Therefore, a shaft seal mechanism 82 is required to prevent working fluid leakage. To completely prevent leakage, the shaft seal mechanism 82 is a labyrinth shaft seal mechanism 82 and the rotational components have to contact the shaft seal mechanism 82. Such a shaft seal mechanism 82 is complicated and is not user-friendly. Moreover, friction between the shaft seal mechanism 82 and the turbine rotor 81 also causes a reduction of the rotational energy.

### SUMMARY

This disclosure provides an embedded turbine generator set, in which an axial-flow turbine and a generator are embedded inside a flow channel so as to prevent working fluid leakage without any shaft seal mechanism.

In one embodiment, this disclosure provides a turbine generator set, comprising: a flow channel, being provided with a front end as an inlet duct and a back end as an outlet duct; an axial-flow turbine, being capable of transforming thermal and pressure energies of a working fluid inside the flow channel into rotational energy; and a generator, comprising a rotor and a stator, being capable of transforming the rotational energy into electricity; wherein the axial-flow turbine and the generator are embedded inside the flow channel, a shaft of the turbine and a shaft of the generator are coupled, and electricity is transmitted from the flow channel by way of a bunch of cables passing through the flow channel.

### BRIEF DESCRIPTION OF THE DRAWINGS

The advantages of the embodiment of this disclosure will be readily understood by the accompanying drawings and detailed descriptions, wherein:

FIG. 1 is a cross-sectional diagram of a conventional turbine generator;

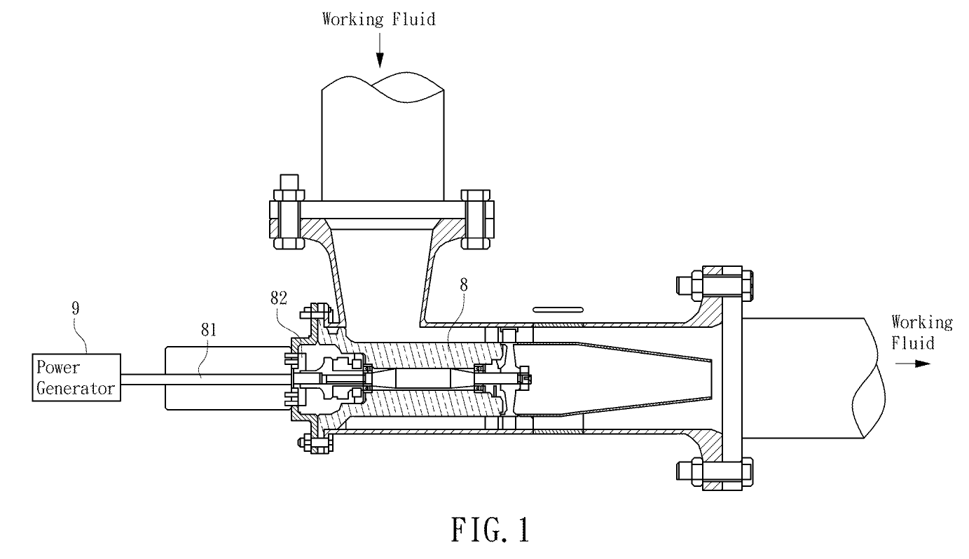

FIG. 2 is a cross-sectional diagram of an embedded turbine generator set according to this disclosure; and

FIG. 3 is a three-dimensional view of an embedded turbine generator set according to this disclosure.

### DETAILED DESCRIPTION OF THIS DISCLOSURE

The disclosure can be exemplified by but not limited to the embodiment as described hereinafter.

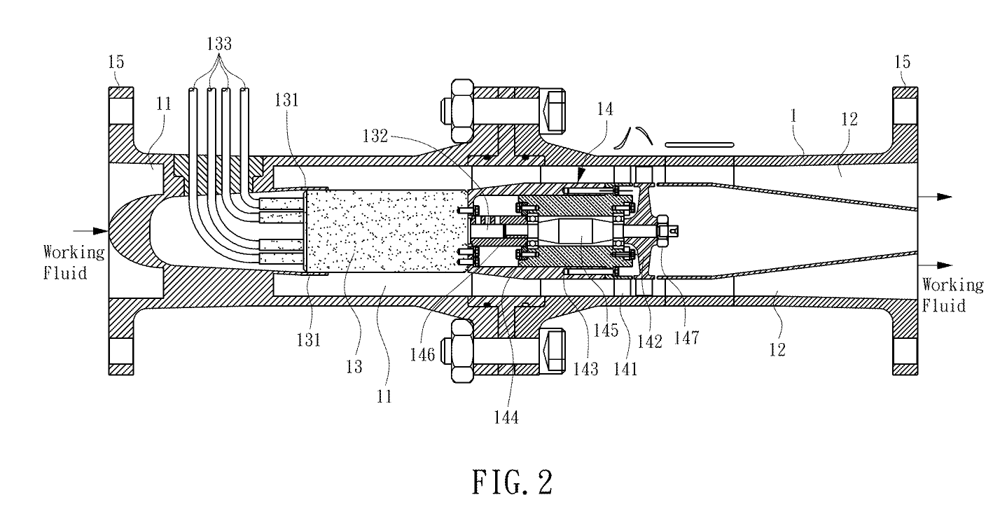

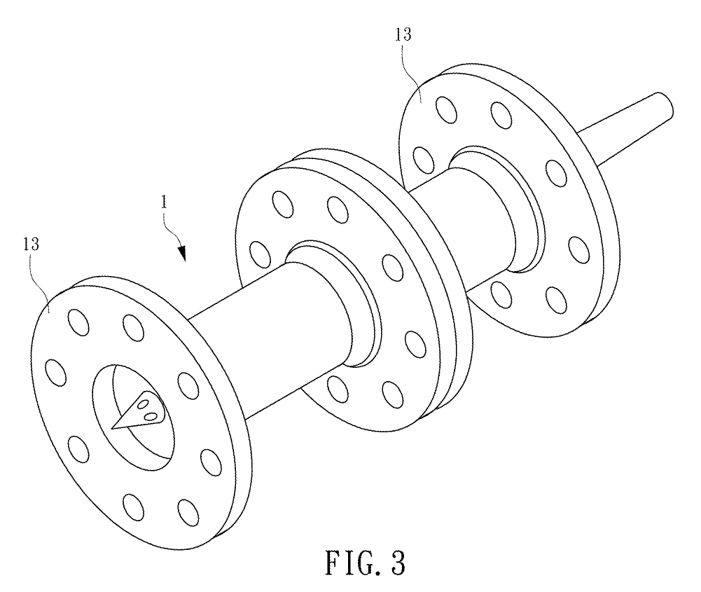

Please refer to FIG. 2 and FIG. 3, which show a cross-sectional diagram and a 3-D view, respectively, of an embedded turbine generator set according to this disclosure. In this disclosure, an axial-flow turbine 14 and a generator 13 are embedded inside a flow channel 1. The axial-flow turbine 14 is single-stage or multi-stage. The flow channel 1 is coupled to a pipeline (not shown). The flow channel 1 is provided with a front end as an inlet duct 11 and a back end as an outlet duct 12. The flow channel is coupled at both ends 15 to the pipeline by way of a flange or a notch structure. Inside the flow channel 1 are disposed an axial-flow turbine 14 and a generator 13. The generator 13 comprises a rotor and a stator so as to transform the rotational energy from the axial-flow turbine 14 into electricity that is to be output by way of a bunch of cables 133. The generator 13 is supported by a support 131. The axial-flow turbine 14 comprises a stator 141 and a rotor 142 so as to transform thermal and pressure energies of a working fluid in the flow channel 1 into rotational energy. Furthermore, the axial-flow turbine 14 further comprises a bearing chamber 143 and a bearing holder 144. The turbine rotor 142 is driven by a working fluid (for example, a coolant being vapor-phase) to rotate. The working fluid flows into the inlet duct 11 and out from the outlet duct 12. The turbine shaft 145 of the turbine rotor 142 is coupled to the generator shaft 132. The turbine rotor 142 and turbine shaft 145 are fixed by a screw bolt 147. The generator shaft 132 rotates to drive the generator 13 to generate electricity. A shaft coupler 146 is disposed outside the turbine shaft 145 and the generator shaft 132 to fix the turbine shaft 145 and the generator shaft 132. The turbine shaft 145 and the generator shaft 132 are coupled directly or by way of a gear set (not shown). The electricity generated is transmitted from the flow channel 1 by way of a bunch of cables 133 passing through the flow channel 1.

Therefore, after the working fluid flows into the flow channel 1 by way of the inlet duct 11, the working fluid propels the turbine rotor 142 to rotate. The working fluid may be a vapor-phase coolant, which is capable of cooling the components in the generator 13 and the axial-flow turbine 14 to prevent the temperature from going up. The turbine rotor 142 rotates to drive the turbine shaft 145 and thus the generator shaft 132 that is coupled to the turbine shaft 145 so as to transform the mechanical energy into electricity. At last, the generator 13 output the electricity by way of the bunch of cables 133.

Unlike the conventional turbine generator that needs shaft seal mechanism to prevent the working fluid from leaking and external gas from entering the flow channel, the turbine generator set in this disclosure, has advantages described herein:

| | The prior art | This disclosure |
|---|---|---|
| Shaft seal | Required | Not required |
| mechanism | | |
| Lubrication on the | Using self-lubricated | Lubricating using |
| bearing | bearing or additional | working fluid |
| | lubricating mechanism | |
| Generator cooling | Gas cooling or water | Cooling using working |
| | cooling | fluid |
| Space required | Additional space needed | Small |
| | for shaft seal mechanism, | |
| | bearing | |
| | lubrication/cooling, | |
| | generator cooling | |
| Efficiency | Friction caused between | Improved efficiency |
| | shaft seal mechanism and | |
| | rotating mechanism; | |
| | additional power | |
| | consumption due to | |
| | bearing lubrication and/or | |
| | generator cooling | |
| Maintenance | Consumables such as shaft | No shaft seal mechanism |
| | seal mechanism need to be | required |
| | replaced | |

In this disclosure, the shaft seal mechanism is not required; and therefore, the problems due to working fluid leakage can be prevented. The working fluid is capable of cooling and lubricating the generator and the bearing. Since the working fluid is prevented from leaking, the working fluid helps to improve the power generating efficiency because the friction between the shaft seal mechanism and rotating mechanism is reduced. Moreover, the maintenance cost of the embedded turbine generator set in this disclosure is reduced since the working fluid will not leak.

Accordingly, it is apparent that this disclosure discloses an embedded turbine generator set, in which an axial-flow turbine and a generator are embedded inside a flow channel so as to prevent working fluid leakage without any shaft seal mechanism. Therefore, this disclosure is novel, useful and non-obvious.

Although this disclosure has been disclosed and illustrated with reference accelerometer to particular embodiments, the principles involved are susceptible for use in numerous other embodiments that will be apparent to persons skilled in the art. This disclosure is, therefore, to be limited only as indicated by the scope of the appended claims.

What is claimed is:

1. A turbine generator set, comprising:
a flow channel, being provided with a front end as an inlet duct and a back end as an outlet duct;
an axial-flow turbine, being capable of transforming thermal and pressure energies of a working fluid inside the flow channel into rotational energy; and
a generator, comprising a rotor and a stator, being capable of transforming the rotational energy into electricity;
wherein the axial-flow turbine and the generator are embedded inside the flow channel, a shaft of the turbine and a shaft of the generator are coupled, and electricity is transmitted from the flow channel by way of a bunch of cables passing through the flow channel.

2. The turbine generator set as recited in claim 1, wherein the working fluid is a coolant.

3. The turbine generator set as recited in claim 1, wherein the axial-flow turbine is single-stage or multi-stage.

4. The turbine generator set as recited in claim 1, wherein the turbine and the generator are directly coupled.

5. The turbine generator set as recited in claim 1, wherein the turbine and the generator are coupled by way of a gear set.

6. The turbine generator set as recited in claim 1, wherein the flow channel is fixedly disposed in the turbine generator set by way of a flange or a notch structure.

7. The turbine generator set as recited in claim 1, wherein a rotor of the turbine and the shaft of the turbine are fixed by a screw bolt.
